(19) United States
(12) Patent Application Publication
(10) Pub. No.: US 2026/0187574 A1
(43) Pub. Date: Jul. 2, 2026

(54) INTERACTIVE DO-IT-YOURSELF MULTIMEDIA CONTENT WITH SENSOR BASED PROGRESS VERIFICATION

(71) Applicant: International Business Machines Corporation, Armonk, NY (US)

(72) Inventors: Siddhartha Sood, Ghaziabad (IN); Abhishek Jain, Baraut (IN)

(21) Appl. No.: 19/007,785

(22) Filed: Jan. 2, 2025

(51) Int. Cl. G06Q 10/0639; G06V 10/75; G06V 40/20; G10L 15/26

(52) U.S. Cl. CPC G06Q 10/06398; G06V 10/75; G06V 40/20; G10L 15/26

(57) ABSTRACT

Mechanisms are provided for generating and presenting interactive multimedia content demonstrating performance of a task. The mechanisms segment the multimedia content into a plurality of segments, each segment corresponding to a sub-task of the task. The mechanisms determine, for each segment, one or more monitoring device identifications for monitoring devices to monitor performance of an associated sub-task of the segment. The mechanisms determine, for each segment, one or more verification criteria for evaluating performance of the associated sub-task. The mechanisms modify, for each segment, metadata of the segment to include the one or more monitoring device identifications and one or more verification criteria, and thereby generate an interactive multimedia content. The mechanisms store the interactive multimedia content in a repository for user access and monitoring of user performance of the task while the user accesses the interactive multimedia content.

### BACKGROUND

The present application relates generally to a data processing apparatus and method and more specifically to a computing tool and computing tool operations/functionality for providing interactive do-it-yourself (DIY) multimedia content with sensor based progress verification.

When a user wishes to perform a task, many times the users will consult video content via the internet and web sites, such as video provider websites, manufacturer websites, and the like, to try to perform the task or troubleshoot issues with a product. However, this process is a passive and non-interactive process where the user merely views or consumes the multimedia content and then is left to their own abilities to implement what they have seen without any further instruction or feedback.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving multimedia content demonstrating performance of a task, and segmenting the multimedia content into a plurality of segments, each segment corresponding to a sub-task of the task. The method further comprises determining, for each segment, one or more monitoring device identifications for monitoring devices to monitor performance of an associated sub-task of the segment. Moreover, the method comprises determining, for each segment, one or more verification criteria for evaluating performance of the associated sub-task. In addition, the method comprises modifying, for each segment, metadata of the segment to include the one or more monitoring device identifications and one or more verification criteria, and thereby generate an interactive multimedia content. Furthermore, the method comprises storing the interactive multimedia content in a repository for user access and monitoring of user performance of the task while the user accesses the interactive multimedia content.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of an interactive Do-It-Yourself (DIY) multimedia system in accordance with one illustrative embodiment;

FIG. 3 is an example diagram illustrating a portion of DIY multimedia content which is segmented and associated with performance verification information metadata in accordance with one illustrative embodiment;

FIG. 4 is a flowchart outlining an example operation for generating augmented DIY multimedia content in accordance with one illustrative embodiment; and

FIG. 5 is a flowchart outlining an example operation for performance verification and feedback generation in accordance with one illustrative embodiment.

### DETAILED DESCRIPTION

The illustrative embodiments provide a computing tool and computing tool operations/functionality for providing interactive do-it-yourself (DIY) multimedia content with sensor based progress verification. The mechanisms of the illustrative embodiments augment multimedia content with sensor input information that can be used to monitor a user's performance of a task to ensure that they are performing the task properly and/or provide feedback regarding the user's performance of the task for correction and learning purposes.

With the proliferation of online content, many individuals now use online multi-media content as a primary source for obtaining answers to questions. This can range from simple search queries on topics of interest to retrieval of “do-it-yourself” (DIY) type content that instructs individuals on how to perform particular projects, repairs, or other tasks. Such DIY content is especially useful for manufacturers and providers of products, as it allows customers of the manufacturers and providers to utilize the products more appropriately, safely, and with greater satisfaction on the part of the customer. Moreover, the availability of such DIY content may be a significant factor in differentiating a manufacturer/provider from competitors and may drive more customers to that manufacturer/provider if customers know that they have valuable support available should they run into any issues with the product or if they want to make maximum use of the product.

While DIY multimedia content is a valuable source of information and instruction, as products become more complex, even these DIY multimedia content may have limited useability by customers. That is, while most customers may easily use DIY multimedia content for installing a toilet seat on a commode, a DIY video explaining how to change the programming of an autonomous car's settings for certain functionality may be more difficult to follow by some customers. This may lead to anxiety, stress, and frustration on the part of the customers. For example, customers may start to view a DIY multimedia content and, due to the complexity, may have to stop the content playback, rewind the content playback several times to review it again, and still may not know whether they are performing the steps of the DIY multimedia content correctly. Moreover, customers may encounter problems because they did something incorrectly but were not aware of it until it was too late to correct the issue.

To attempt to help customers in using products, manufacturers and providers may provide help documentation, support user groups/forums, frequently asked questions documentation, “what's new” videos to illustrate new features of new versions of products, and the like. However, these solutions are static and non-interactional, placing all of the responsibility on the customer/user to utilize these sources of assistance properly. This again leads to frustration and dissatisfaction on the part of customers/users who may not completely understand the information provided, have limited time to digest such information, or the like.

To address the limitations of existing DIY multimedia content computing systems, the illustrative embodiments provide mechanisms for segmenting DIY multimedia content into segments corresponding to execution steps/chunks and utilizing sensors, cameras and computer vision tools, machine software development kit (SDK) application programming interfaces (APIs), and other monitoring equipment and software to verify proper performance of the steps/chunks and provide feedback for when the performance varies from proper execution of the steps/chunks. The mechanisms of the illustrative embodiments may operate in multiple different modes of operation, e.g., learning mode, autonomous mode, and end user mode, to thereby build interactive DIY multimedia content. In learning mode, users are permitted to make drifts, mistakes, or errors in the performance of a task which feedback being provided after the task is performed. The system may take inputs from sensors, cameras, and the like, to monitor the user's performance of the steps of the process and match those with the metadata associated with the segments and the images of each segment. Thereafter, the system may present a feedback report identifying where the user deviated and by how much. In this way, users learn how to perform tasks as well as learn the consequences of deviations from proper performance by the correlation to the segments and viewing the progression of deviations.

In end user mode, real time feedback is communicated as drifts, mistakes, or errors are detected on a segment-by-segment basis. In this way, the end user is more immediately corrected. This mode may be used when a user wishes to just accomplish the task in the right way the first time rather than trying to learn the procedure on their own with guidance like in the learning mode of operation.

In autonomous mode, for some tasks that do not require physical interaction by a user, the task may be completed autonomously by corresponding computing systems. That is, some tasks may be more programmatic, merely involve modification of settings, or other operations that are done entirely in software or electronically from one computing device or control unit and another. In such cases, no physical modification or configuration of the product is necessary and the task can be completed entirely electronically. In such cases, the autonomous mode may be implemented.

It should be appreciated that these different modes may be associated with the DIY multimedia content as a whole, or to individual segments of the DIY multimedia content. In the latter case, a DIY multimedia content may have different modes of operation for different segments of the DIY multimedia content, e.g., some segments may be performed in learning mode, some in end user mode, and some in autonomous mode. The applicability of the different modes may be specified by a SME or may be automatically determined based on the types of sensor input used for performance verification associated with the different segments.

With the mechanisms of the illustrative embodiments, taking any authenticated DIY multimedia content such as video, audio (podcast), help text (help guide, blogs etc.), or the like, a segmentation engine segments the content into a series of individual steps/chunks by leveraging artificial intelligence (AI) and complex digital analysis techniques, such as video splitting for identifying video frames, speech-to-text for converting audio to textual equivalents, natural language processing (NLP) and language models (LMs) or large language models (LLMs) to understand spoken language, and the like. These AI mechanisms utilize machine learning (ML) training computer models to analyze the DIY multimedia content and determine segments of the DIY multimedia content. For example, with video content, the images of the video content may be broken down into frames and groups of frames representing similar images may be combined into segments to form a series of segments. With DIY multimedia content, the segments may represent different parts of a process for completing a task.

The segments of the DIY multimedia content may be augmented with metadata specifying the particular sensor inputs that are needed to verify proper performance of the parts of the process represented by that segment. The augmentation of the segments may be performed by a subject matter expert (SME) who may specify the types of sensor input to gather for that segment, the required or correct values of the sensor input to indicate proper performance of that part of the process based on the sensor input, and types of feedback information to provide to users should a deviation of the sensor input from the required or correct sensor input. The sensors may be IOT sensors, software application communications and values generated by software components, camera, video or other image capture device inputs, image analysis software results, audio capture device inputs, and the like. A combination of sensor inputs may be specified, e.g., image analysis may be used to compare captured images to the frames of the segment to determine deviations from expected images, while sensor inputs from sensors associated with components involved in the performance of the process may be captured to perform other verifications (e.g., a sensor detecting proper engagement of two parts may be used to provide a signal to a computing system of the vehicle indicating proper installment of a part).

Thus, each segment of the DIY multimedia content is enriched with progress verification information that is thereafter associated with that segment of the DIY multimedia content such that it may be accessed along with the DIY multimedia content by one or more users. The progress verification information is metadata that specifies various types of progress verification information, such as associated sensors, SDK documentation and availability of camera angles to determine which specific progress verification information will be leveraged. Thus, each segment is mapped to progress verification information and a determination may be made as to which segments, if any, cannot have their progress measured either because the segments do not have corresponding progress verification information associated with them, sensors required for certain segments are not available or operational, or any other reason based on the presence/non-presence of progress verification information or working sensors, cameras, or the like, needed to monitor the progress of particular segments.

When a user selects to consume a DIY multimedia content automated with progress verification information in accordance with the mechanisms of the illustrative embodiments, the user's profile/preferences may be retrieved from a user profile registry. Based on the user's profile/preferences, and the metadata associated with the segments of the DIY multimedia content, particular verification modes may be determined to be used with the DIY multimedia content, or specific segments of the DIY multimedia content. For example, the three modes of operation discussed above may be available, and based on the user's profile/preferences, either the learning or the end user modes may be selected, or in some cases the automated mode may be utilized. Thus, depending on which modes are enabled for the multimedia content and/or segments as indicated by the metadata, all or a subset of these modes may be options. Then, the user profile/preferences may be used to specify which mode to use for this particular user. For example, even though both end user and automated modes may be available, the user's preferences may state that this user wishes to learn the processes and thus, a learning mode may be selected instead.

Based on the DIY multimedia content, the progress verification information for the segments of the DIY multimedia content, and the user's preferences, the system of the illustrative embodiments will build the interactive execution workflow for the DIY multimedia content when presenting it to the user for performance of the corresponding task. The execution steps for the task, progress verification information, and verification modes will be mapped to create the execution workflow.

The system will then present the interactive workflow to the user for validation and execution via a user associated computing device. This computing device may include an application or API for performing the interactive DIY multimedia content consumption to perform the task, may be a computing device coupled to the subject of the task, or the like. The user's computing device is preferably one that is in communication with the required sensors, cameras, computing devices, and software needed to track the progress of the performance of the task in accordance with the progress verification information associated with the segments of the DIY multimedia content. This communication may be through wired and/or wireless data communication connections between the user's computing device and the sensors, cameras, or computing devices and software associated with monitoring the product and/or environment of the product when performing the task represented in the DIY multimedia content. For example, in the case of an automotive repair, the user's computing device may be a user's mobile smartphone executing an application through which the user consumes the DIY multimedia content and which, through the application, communicates with the automobile's onboard computing system and its associated sensors and cameras to get information to monitor the progress of the user performing a repair task.

As the user progresses through the interactive flow of the DIY multimedia content by viewing/consuming the DIY multimedia content segment by segment, the system will capture sensor information, camera images, audio input, and the like. This captured information may be compared against the progress verification information to determine a level of matching or mismatching, again on a segment by segment basis, in real-time. This comparison may compare captured sensor values to the correct sensor values, sensor value ranges, or the like, specified in the progress verification information, may utilize computer vision mechanisms to detect objects and entities and correlate them with object/entities of frames of the DIY multimedia content for the particular segment to determine whether there is a match or mismatch using fuzzy logic or thresholds to allow for minor discrepancies, or the like. In this way, the system will identify drifts and mistakes during execution and, based on the configuration, communicate mistakes back to the user (end user mode) and/or hold them for communication till the end of the task (learning mode).

As the user is consuming the DIY multimedia content and the user's progress is being tracked, the system may provide a visual and/or audible feedback of the confidence factor for the user's performance of that portion of the task. This may be done on a segment by segment basis as each segment is completed. The visual/audible feedback may indicate to the user whether they completed the segment successfully or if there were drifts or mistakes made during their performance of that portion of the task. The feedback may specify which sensor values or images were mismatched so that the user is informed of what part of the segment was performed incorrectly. At the end of the consumption of the DIY multimedia content, the user may be presented with a summary of the performance of the task, such as indicators of drifts, deviations, and errors made by the user during the performance of the task.

Thus, the mechanisms of the illustrative embodiments provide an interactive step-by-step process for instructing individuals on how to perform DIY projects in a manner that provides for monitoring of the performance of the various steps or parts of the task and providing constructive feedback either in real-time with regard to individual segments and/or at the end of the project so as to inform the individuals of their drifts, deviations, and errors occurring during the process. The type of feedback provided may be dependent upon individual preferences and the availability of such feedback for the DIY multimedia content as a whole or even individual segments. In some cases, the system can automatically perform all or some of the steps of a task on behalf of the individual, such as when in automated mode. As a result, the individual is provided with a more satisfactory DIY experience as they are given feedback specific to their particular performance of the task. Moreover, the availability of such interactive DIY multimedia content can serve as a promotional aspect for manufacturers and providers of products to thereby differentiate themselves from other competitors.

The illustrative embodiments are applicable to many different use cases for assisting individuals with the performance of DIY projects or tasks. Taking an example that is less complex, one use case may be a scenario where a person wants to perform a wiper blade replacement on their vehicle. In this case, the user must either follow the car manual guide or explore on their own, e.g., by taking help from someone that is more experienced. Sometimes, the user does not have time to explore and read manuals and perform all instructions end to end to before determining whether the desired goals were accomplished. The user would feel much comfortable either by following a related video or reading a relevant blog and pausing it in-between steps so that they can perform the task up to that point, get the progress validated, and then move on to the next part of the task.

As another example use case, consider a scenario where a person wants to synchronize a vehicle clock time to a different time zone. In this case, the user may again either follow the car manual guide or explore on their own, and again may not have the time to explore or ready manuals. Thus, again, the user may choose to watch a related video or read a relevant blog on the internet so that they can quickly learn and accomplish their goal.

In this search process on the internet, it may be determined that there is a large volume of possible videos and blogs available which describe the same problem to accomplish the task. However some of this content may not be reliable or validated as being authentic and able to be trusted by the user. Thus, the user may end up watching multiple videos and reading multiple blogs to get a clear instruction on how to address their problem. Thus, sometimes the task can be achieved easily when the user is able to identify a clear and validated video/blog, while other times it may be difficult to find a clear and validated set of instructions to follow.

Consider also a manufacturing scenario where a set of execution steps have been recorded from a seasoned professional and must be now executed by a new professional. Here, even though the new professional has access to all the recorded learning and execution demonstrations, there may still be anxiety and stress as the steps are being executed for the first time and hence, the new professional would feel more comfortable playing and pausing the content until each step is understood and executed back. The scenario demonstrates the need for an improved computing tool and improved computing tool functionality which can break authenticated content into a series of verifiable steps, where progress can be validated via a combination of associated software (computer vision) and/or hardware (IOT sensors), relieving users of the anxiety and stress of pausing the content, follow the steps and not knowing if they are headed in the right direction and have not missed anything.

Each of the above scenarios, and many others, are addressed by the mechanisms of the illustrative embodiments through the interactive DIY multimedia content with progress verification mechanisms as described above. With the mechanisms of the illustrative embodiments, by segmenting the DIY multimedia content into separate segments corresponding to particular steps of a process for performing a DIY project, the DIY multimedia content becomes more useable to the user/customer. Moreover, by providing interactive feedback with the customer/user based on their performance of the DIY project steps relative to the DIY multimedia content, the user/customer (hereafter simply “user”) is provided with immediate feedback as to whether or not they are performing the steps of the DIY project properly or not.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides functionality for an interactive do-it-yourself (DIY) multimedia content presentation and performance verification that improves presentation of instructional content to assist individuals in performing tasks. The improved computing tool implements mechanism and functionality, such as an interactive DIY multimedia system, which cannot be practically performed by human beings either outside of, or with the assistance of, a technical environment, such as a mental process or the like. The improved computing tool provides a practical application of the methodology at least in that the improved computing tool is able to provide an interactive DIY multimedia experiences with specific sensor, camera, and artificial intelligence monitoring and evaluation of the performance of the DIY tasks so as to provide feedback to the individual as to the correctness or incorrectness of their performance.

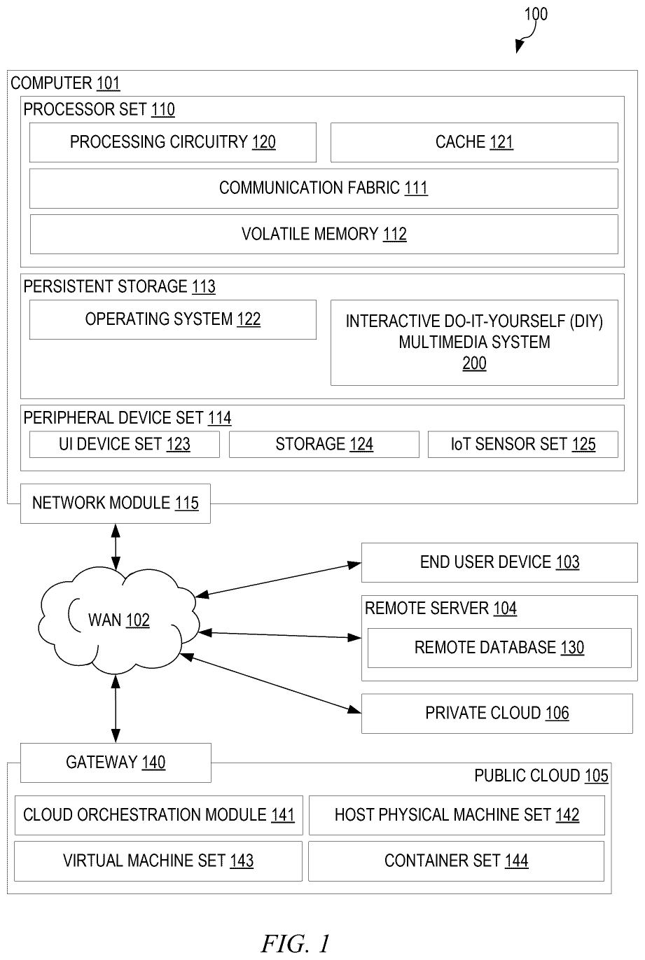

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as interactive DIY multimedia system 200. In addition to interactive DIY multimedia system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and interactive DIY multimedia system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in interactive DIY multimedia system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in interactive DIY multimedia system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement an interactive DIY multimedia system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates presentation of an interactive DIY multimedia presentation with sensor, camera, and AI based performance verification with user feedback.

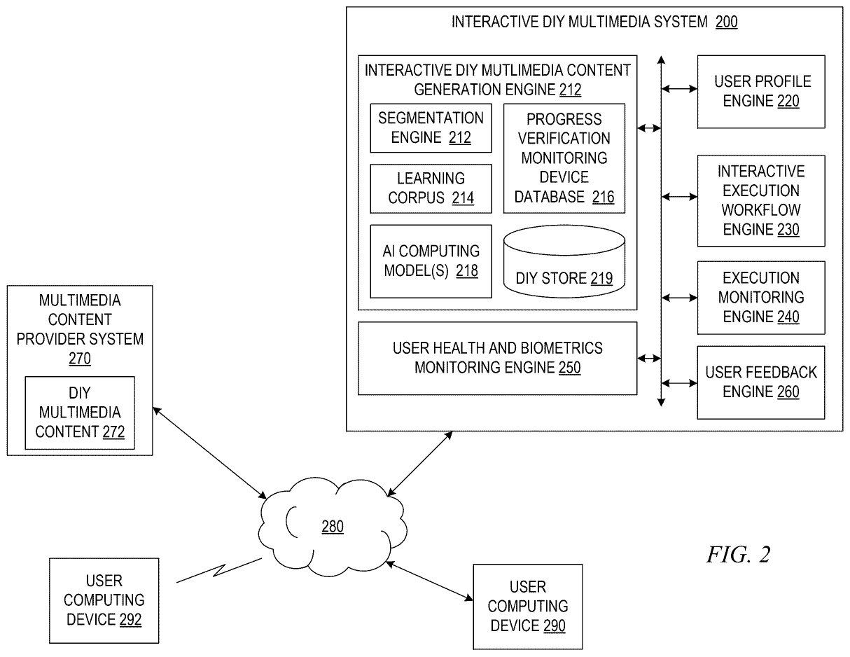

FIG. 2 is an example block diagram illustrating the primary operational components of an interactive DIY multimedia system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that that DIY multimedia content is presented to users, and providing a specific solutions to the passive nature of DIY multimedia content noted above, i.e., just being viewed or consumed by users without any interactive features or verification of performance, where the solution specifically interacts with sensors, cameras, and AI computing systems to evaluate performance in accordance with augmented DIY multimedia content and provide feedback to users regarding the performance, which cannot be practically performed by human beings as a mental process and is not directed to organizing any human activity.

As shown in FIG. 2, the interactive DIY multimedia system 200 (hereafter referred to as simply the “system” 200) includes an interactive DIY multimedia content generation engine 210 (hereafter referred to simply as the “generation engine 210”) comprising a DIY multimedia content segmentation engine 212 (hereafter referred to simply as the “segmentation engine” 212), a learning corpus 214, a progress verification monitoring device database 216, and one or more artificial intelligence (AI) computing models 218 that are trained through machine learning processes to determine for a given segment of the DIY multimedia content, and based on the learning corpus 214 and progress monitoring device database 216 data, the appropriate monitoring devices and their corresponding values or range of values to use for monitoring performance of a portion of a task corresponding to the segment. The generation engine 210 generates the interactive DIY multimedia content which may then be stored in an interactive DIY multimedia content store 219 and/or provided back to an original provider of the non-interactive DIY multimedia content which is the basis for the interactive DIY multimedia content 219.

In addition to the pre-configuration engine 210, the system 200 includes a user profile engine 220, an interactive execution workflow engine 230, an execution monitoring engine 240, a user health and biometrics monitoring engine 250, and a user feedback engine 260. The user profile engine 220 provides logic for storing and accessing user profiles that specify user preferences for various verification modes for interaction with interactive DIY multimedia content. The interactive execution workflow engine 230 provides the logic for presenting an interactive execution workflow corresponding to an interactive DIY multimedia content for consumption by a user while monitoring performance of a task by the user during that consumption and providing feedback to the user as to the correctness/incorrectness of their performance. The execution monitoring engine 240 provides the logic for collecting sensor, camera, API, and other inputs from monitoring devices to evaluate the user's performance of portions of a task corresponding to segments of the interactive DIY multimedia content. The user health and biometrics monitoring engine 250 provides logic that may, if permitted by user permissions set forth in user profiles, monitor user health and biometric monitoring devices to obtain information about the anxiety and stress of the user while performing portions of the task. The user feedback engine 260 provides the logic for generating and presenting user feedback to the user via their computing device in accordance with the interaction mode being utilized.

The generation engine 210 operates on a given DIY multimedia content 272 from a content provider computing system 270 obtained via one or more data networks 280. The content provider computing system 270 may be associated with an entity, such as a manufacturer of a product, a provider of a product, a third party content provider, or the like, which provide multimedia content for use by users to perform DIY tasks with regard to a particular product. For example, a car manufacturer may provide videos showing how to perform repairs on their cars. In some cases, the videos may be generated by other users to help inform a community as to how to perform certain tasks, with these videos being uploaded to a well-known video provider website or the like. The content, e.g., DIY multimedia content 272, may be accessed by users via one or more user computing devices 290-292 via the one or more data networks 280 and the content provider computing system 270. It should be appreciated that prior to processing of the DIY multimedia content 272 by the system 200, the DIY multimedia content 272 does not have an interactive aspect and does not have the necessary progress verification information as metadata of the DIY multimedia content 272 that is needed to perform intelligent progress verification using sensors, cameras, APIs, and the like. To the contrary, the DIY multimedia content 272 is passive and merely able to be viewed/consumed by the user, as is generally known in the art.

The content provider computing system 270 may enlist the system 200 to generate interactive DIY multimedia content based on the providing of the DIY multimedia content 272 to the system 200 for processing. The system 200 may generate the interactive DIY multimedia content and may host that content in the storage 219 for access by users, e.g., users attempting to access the content 272 may be redirected to the storage 219, for example. Alternatively, the system 200 may generate the interactive DIY multimedia content and provide that interactive DIY multimedia content back to the content provider computing system 270 along with logic for monitoring performance and generating feedback in accordance with the illustrative embodiments. For purposes of the present description it will be assumed that the interactive DIY multimedia content is hosted in the storage 219 and accessible by users of user computing devices 290-292, either through a direct connection or redirect from the content provider computing system 270.

In generating the interactive DIY multimedia content, the generation engine 210 first invokes the segmentation engine to segment the provided DIY multimedia content into logical segments based on an analysis of the provided DIY multimedia content. This analysis may involve the use of pre-trained machine learning (ML) computer models that operate on test, images, and videos to determine segment borders in the content. Various technologies exist to automatically segment multimedia content, such as Key Moments™ by Google® or the like, which may be used to generate the segments of the provided DIY multimedia content. The segmentation engine 212 implements or invokes one or more of these existing technologies to determine segmentation timestamps and borders of segments in the provided DIY multimedia content. It is preferable that this segmentation be configured to segment the provided DIY multimedia content so as to generate segments that align with different steps or parts of an overall task or process.

For example, if the provided DIY multimedia content is a video instructing users how to change their wiper blades on a particular automobile, the segmentation engine 212 may segment the video into a plurality of segments corresponding to the steps of the process or task as follows:
1. Move the wipers to the service position.
2. Lift the wiper arm a short distance away from the windshield.
3. Unlock wiper and slide wiper down.
4. Remove wiper from wiper arm.
5. Align new wiper and slide up on wiper arm.
6. Assure wiper locks in place on wiper arm.
7. Return the wipers to their normal position.
   Each segment has corresponding metadata that specifies the borders of the segment, e.g., timestamps, and the content of the segment, which may be extracted from audio-to-text generation, natural language processing, and the like.

Having generated the segments of the provided DIY multimedia content, the learning corpus 214 may be leveraged to identify categories of tasks and/or sub-tasks, and the verification modes that are configured for monitoring those categories of tasks and/or sub-tasks. For example, for each category of task/sub-task there may be associated verification modes specifying one or more of the verification modes of learning, end user, or autonomous. This provides an indication of which verification modes are available, but the particular verification mode actually utilized during consumption by a particular user may be further based on the user's preferences, as discussed hereafter.

The progress verification monitoring device database 216 stores information specifying the types of monitoring devices available for monitoring performance of tasks with regard to particular products and/or parts of the particular products. These monitoring devices may be IOT devices, e.g., integrated sensors of the product, camera feeds from cameras associated with the product or a user device, SDK and software components, and the like. The database 216 may specify that for particular parts of a product, what monitoring devices monitor that part of the product and/or are positioned or can be positioned to monitor that part of the product. For example, for an automobile, there may be a sensor in the wiper blade arm that monitors whether the wiper blade is aligned and locked in place, there may be a front-facing camera mounted inside the windshield behind the rear-view mirror that can be used to capture images of the wiper blades, a user's camera in their hand-held computing device may be used to capture and feed images of the wiper blades, etc. These may be specified in association with a task of replacing a wiper blade, or individual sub-tasks such as 1-7 above.

The AI computing models 218, which may be trained through machine learning processes, take as input the segment metadata, the learning corpus 214, the progress verification monitoring device database 216 information for the segments, and determine for each segment and/or the segmented DIY multimedia content as a whole, the monitoring devices and their corresponding values or range of values to use for monitoring performance of a portion of a task corresponding to each segment. That is, the AI computing models 218 determine what verification mode to use with each segment, what monitoring device or devices to use to monitor the performance of the sub-task for that segment, and the criteria by which to measure correct/incorrect performance of the sub-task. This criteria may require certain values, e.g., 1 if locked in place, 0 if not locked in place, particular object orientations in images, particular acceptable range of values, or the like. It should be appreciated that each segment may have one or more verification modes available, one or more monitoring devices available, and one or more criteria specified for monitoring and verifying proper performance of that corresponding sub-task.

The determinations made by the AI computing models 218 may be stored as additional metadata associated with the segments and/or interactive DIY multimedia content as a whole, and is referred to as verification information herein. This verification information will specify the particular sensors, cameras and camera angles, software components, APIs, and the like, that may be used to monitor performance of the particular sub-task of each segment as well as the criteria by which to measure the inputs received from the monitoring devices for evaluating correct/incorrect performance of the sub-task. The generation engine 210 may evaluate the resulting interactive DIY multimedia content that is generated to ensure that there is a sufficient number of sub-tasks that may be monitored and verified using the verification information to ensure that a user is properly performing the overall task. If there is insufficient verification information to perform such verification, then the DIY multimedia content provider may be informed that an interactive DIY multimedia content was not able to be generated.

It should be appreciated that during the above process for generating interactive DIY multimedia content, results of any of the operations may be presented to a human subject matter expert (SME) for validation of the results generated by that operation and/or for user input to specify additional verification information to be associated with the particular segment. For example, the generation engine 210 may be used to automatically generate the interactive DIY multimedia content and the SME may be presented with the result of this generation. The SME may then review the generated interactive DIY multimedia content and add, remove, or modify the verification information as deemed appropriate to ensure a desired performance verification when users utilize the interactive DIY multimedia content to perform the corresponding task. This may be especially useful when the system 200 determines that there is insufficient verification information for generating of an interactive DIY multimedia content. This determination may be presented to a SME along with the verification information for segments that were able to be generated, such that the SME may “fill in the blanks” for segments where there is insufficient verification information generated by the system 200. Thus, in some cases a semi-automated generation of the interactive DIY multimedia content may be implemented when needed.

Users may access interactive DIY multimedia content from the storage 219 for presentation on their user computing devices 290-292. The identity of the user, or user's computing device 290-292, may be determined, such as from MAC address, user logon credentials, or the like, and may be correlated with a user profile stored and accessible by the user profile engine 220. The user profile for a particular user specifies that user's preferences with regard to the presentation, monitoring, and feedback provided during an interactive experience with interactive DIY multimedia content. For example, the user's preferences may specify a desired, or priority, of the various available verification modes, e.g., learning, end user, and autonomous, as well as other preferences for the presentation, monitoring, and feedback, e.g., language used, size of text messages, permissions to access health and biometrics data from monitoring devices, etc. The user's preferences, along with the available verification modes for each segment of an interactive DIY multimedia content, are used to build an interactive workflow for execution, perform monitoring during the interactive workflow execution, monitor user health and biometrics, and provide feedback to the user via their user device 290-292.

The interactive execution workflow engine 230 provides the logic for generating the interactive execution workflow based on the user preferences and the verification information associated with a particular interactive DIY multimedia content selected for consumption by the user. In generating this interactive execution workflow, the engine 230 determines for each segment which mode(s) to utilize, which monitoring devices to utilize, and what type of feedback, if any, is to be provided to the user's computing device 290-292. This interactive execution workflow will be the workflow followed during presentation of the interactive DIY multimedia content to the user's computing device 290-292 and serves as the foundation for the interaction and monitoring of the performance of the task. The interactive execution workflow may require data communication between the system 200 and the user's computing device 290-292 during the presentation and monitoring of the task, as well as the various monitoring devices being utilized. The system 200 may communicate with these monitoring devices directly via the data network(s) 280 or may communicate via the user's computing device 290-292 acting as a middleman between the monitoring devices and the system 200. In cases where the user's health and biometrics are monitored in addition to the other monitoring devices directed to monitoring performance of the task, the health and biometric information may be received via an application and API of the user's computing device 290-292.

As noted above, in some illustrative embodiments, three different types of verification modes are provided that the user may set preferences for, i.e., learning mode, end user mode, and autonomous mode. In the learning mode, the system 200 will configure the interactive execution workflow in a way where drifts, mistakes, and errors are detected in real-time and collated in a repository to be communicated at the end of the presentation of the interactive DIY multimedia content and performance of the task. In this verification mode, these drifts, mistakes, or errors can lead to a state where, due to discrepancies in the execution between the desired flow and actual flow, the user may not be able to move forward in completing the task. However, in the learning mode, this inability to complete the task is acceptable as the user has indicated a desire to learn the process for completing the task, not just complete the task.

In the end user verification mode, the system 200 will configure the interactive execution workflow in a way where drifts, mistakes, and errors are detected in real-time and will be communicated to the user via their user computing device 290-292 substantially immediately upon detection of such drifts, mistakes, and errors. This feedback communication may take many different forms depending on the desired implementation, e.g., textual alerts, graphical alerts, audible alerts, etc., and will generally indicate the drifts, mistakes, or errors and provide information for rectifying the drifts, mistakes or errors. This interactive verification mode is less likely to lead to a discrepancy in the performance of the task and sub-tasks as the user is informed substantially immediately rather than waiting for the execution to stall or complete. This avoids a compiling of drifts, mistakes, or errors from one segment or sub-task to another. Moreover, this interactive verification mode is more likely to reduce user anxiety and stress and is also more likely to result in the user accomplishing the task successfully.

In the autonomous mode of interactive execution workflow, the task or sub-task is completed in real-time through autonomous execution by the user computing system 290-292, the product computing system(s) (not shown), or a combination of these computing systems. Such autonomous verification mode is only available to tasks/sub-tasks that can be completed without human interaction. For example, when the overall progress of the task or sub-task can be validated via an application pluggable to a device SDK and or through integration with an IOT sensor, the option for autonomous verification mode may be enabled for that task or sub-task and its corresponding segments in the interactive DIY multimedia content.

Once the interactive execution workflow engine 230 generates the interactive execution workflow for the selected interactive DIY multimedia content and the user, the interactive DIY multimedia content is presented to the user via the user's computing device 290-292 in accordance with the interactive execution workflow. This may require an application on the user's computing device 290-292 through which this interactive execution workflow is executed in some cases. Alternatively, in some illustrative embodiments, the user's computing device 290-292 may operate in more of a media presentation capacity with user inputs being for controlling the media presentation, e.g., stop, rewind, fast forward, etc., with the monitoring, verification, and feedback generation being performed by the system 200 and forwarded to the user's computing device 290-292 for presentation to the user.

During presentation of the interactive DIY multimedia content, the execution monitoring engine 240 monitors the user's execution of the task/sub-tasks associated with the segments of the interactive DIY multimedia content. This monitoring involves collection of monitoring device data, e.g., sensor data, camera images, software outputs, etc., and comparison to the verification information for the segments to determine any discrepancies, e.g., drifts, mistakes, or errors, in the performance of the task/sub-tasks. The particular monitoring devices from which the data is collected is dependent upon the verification information associated with the particular segment and the interactive execution workflow generated by the interactive execution workflow engine 230.

The execution monitoring engine 240 may implement one or more AI computer models to evaluate the monitoring device data stream received from the monitoring devices in real-time and determine the level of correct/incorrect performance of the task/sub-tasks. These AI computer models may generate quantifiable confidence scores to indicate a level of confidence in the user's performance of the tasks/sub-tasks correctly/incorrectly. This may then drive particular natural language feedback generation, feedback graphic generation, and/or audible feedback generation in order to give the user an indication of how well or how poorly they are performing the task/sub-task. As noted above, this feedback may be presented to the user in accordance with the determined verification mode for the segment(s).

In some illustrative embodiments, the system 200 is able to interact with user health and biometrics monitoring devices, e.g., smart watches, smart rings, wearable health monitors, and the like, to obtain data about the user's personal health and biometrics, e.g., heart rate, perspiration levels, blood pressure, temperature, etc. This health and biometric data may be used to evaluate the level of anxiety, stress, and frustration on the part of the user while performing the task/sub-tasks. This evaluation may be used to further drive the type of user feedback presented to the user as a part of the interactive DIY multimedia content presentation and may, in some cases, be used to override the particular verification mode preferred by the user. That is, even though the user may have preferred a learning verification mode, if it is determined that the user is exhibiting signs of high anxiety, stress, or frustration during a particular segment, the learning verification mode may be overridden and the verification mode may be changed to an end user mode temporarily so as to provide immediate feedback to the user in hopes of reducing anxiety, stress, or frustration. Moreover, specific feedback directed to the particular health or biometric data may be presented, e.g., “It appears that this sub-task may be stressful, take a break and we can restart in a moment”, or the like.

The user feedback engine 260 provides the logic for generating the particular user feedback that is presented to the user via their user computing device 290-292. The user feedback may take the form of textual, graphical, and/or audible content that informs the user of the progress of a task/sub-task associated with the interactive DIY multimedia content. This may include textual, graphical, and/or audible content specifying discrepancies between the user's actual performance of tasks/sub-tasks and the required or correct values, images, and the like of the verification information for the segments, content specifying detected health and biometric data, as well as any additional information to assist users in addressing such discrepancies and/or any detected health/biometric issues. The user feedback is generated as performance of tasks/sub-tasks is on-going in real-time, but may be presented to the user in accordance with the particular verification mode. Thus, in end user verification mode, the feedback may be presented virtual immediately when discrepancies, or health/biometric issues, arise and/or when segments are completed. In learning verification mode, the feedback may be generated in real-time, but its presentation held until the performance of the task is stalled due to an inability to proceed, or the task is completed. The stalling of the task may be determined by an elapse in time greater than a threshold amount of time, in which no further progress to a next segment is detected by the monitoring devices.

Thus, the illustrative embodiments provide an improved computing tool and improved computing tool operations/functionality that solve the problems with existing DIY multimedia content presentation in that the illustrative embodiments provide a more interactive experience with active real-time feedback generation based on real-time monitoring of user performance of a corresponding task and its sub-tasks. The illustrative embodiments provide mechanisms for associating with individual segments of the DIY multimedia content, the particular monitoring devices that can be used to monitor performance of that segment's task/sub-task as well as the criteria by which to evaluate the performance using those monitoring devices. The illustrative embodiments provide mechanisms for generating an interactive execution workflow which then is used to present, monitor, and provide feedback with regard to the interactive DIY multimedia content. As a result, a more interactive and rewarding experience for users is provided that will lessen anxiety, stress, and frustration of users when performing DIY projects. Moreover, the mechanisms of the illustrative embodiments make it possible of providers of products to provide additional value added content for users that may differentiate them from market competitors.

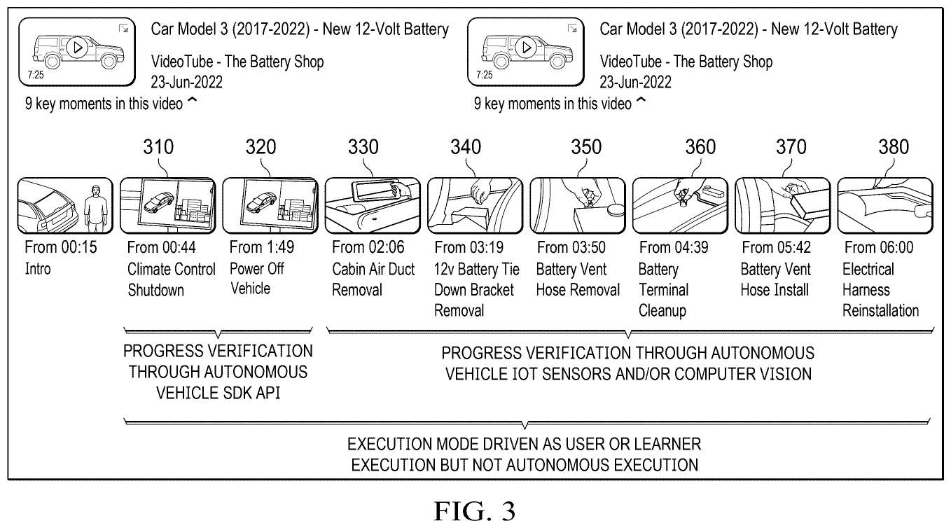

As noted above, a significant aspect of the illustrative embodiments is the segmentation of DIY multimedia content and the association of verification information with the segments of the DIY multimedia content. FIG. 3 is an example diagram illustrating a portion of DIY multimedia content which is segmented and associated with performance verification information metadata in accordance with one illustrative embodiment. The DIY multimedia content of the depicted example is for the installation of a 12-volt battery in an electric automobile. As can be seen from FIG. 3, the DIY multimedia content is segmented into a plurality of segments which have timestamp borders and corresponding textual descriptions indicating the steps of the process that are represented by the various segments, i.e., the sub-tasks.

In the particular example of FIG. 3, the segments comprise an introduction which has no corresponding verification information, a segment 310 for climate control shutdown, a segment 320 for powering off the vehicle, a segment 330 for cabin air duct removal, a segment 340 for 12V battering tie down bracket removal, and segment 350 for battery vent hose removal, a segment 360 for battery terminal cleanup, a segment 370 for battery vent hose installation, and a segment 380 for electrical harness reinstallation. With the operation of the illustrative embodiments, the segments 310 and 320 are determined to be segments whose sub-tasks may be performed autonomously and thus, an autonomous verification mode is associated with these segments 310 and 320. In addition, the monitoring device designation for these segments 310 and 320 is determined to be the vehicle SDK API as the API will indicate when the climate control system is shutdown and the vehicle power is off.

The segments 330-380 are determined to be segments that require user interaction and thus, the learning and end user verification modes are associated with these segments. The monitoring devices used to determine correct/incorrect performance of the sub-tasks for these segments are determined to be various IOT sensors in the vehicle and/or computer vision devices, e.g., cameras and corresponding software, mounted in or on the automobile or held by the user when performing the sub-tasks. It should be appreciated that the particular verification mode selected for these segments 330-380 is dependent upon user preferences, e.g., preference between learning mode or end user mode.

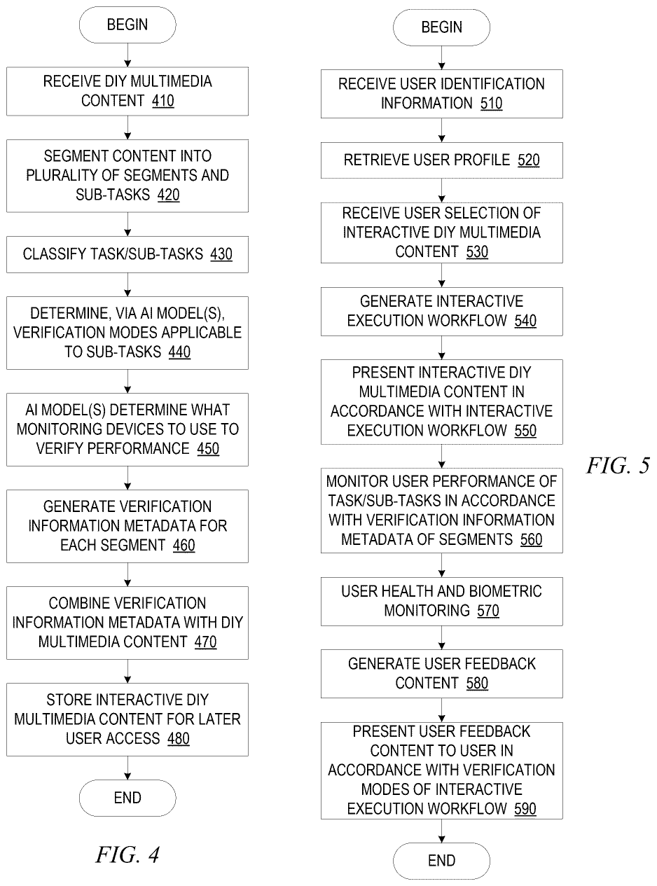

FIGS. 4-5 present flowcharts outlining example operations of elements of the present invention with regard to one or more illustrative embodiments. It should be appreciated that the operations outlined in FIGS. 4-5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4-5, and may, in some cases, make use of the results generated as a consequence of the operations set forth in FIGS. 4-5, the operations in FIGS. 4-5 themselves are specifically performed by the improved computing tool in an automated manner.

FIG. 4 is a flowchart outlining an example operation for generating augmented DIY multimedia content in accordance with one illustrative embodiment. As shown in FIG. 4, the operation starts with the receiving of DIY multimedia content for processing and generation of an interactive DIY multimedia content version (step 410). The received content is segmented into a plurality of segments corresponding to sub-tasks of the overall task represented in the received content (step 420). The task/sub-tasks are classified into classes of tasks/sub-tasks (step 430). A learning corpus and progress verification monitoring device database are processed by one or more AI computer models, along with the segment information and task/sub-task classifications, to determine, for each segment, which verification modes are applicable to the sub-task of that segment (step 440). Similarly, the AI computer model(s) determine which monitoring devices may be used to verify performance of the sub-tasks for each segment (step 450). The results of these determinations are used to generate verification information metadata for each segment of the DIY multimedia content (step 460). The verification information metadata is combined with the DIY multimedia content to generate the interactive DIY multimedia content (step 470). The interactive DIY multimedia content is then stored in a storage for later user access (step 480) and the operation terminates.

FIG. 5 is a flowchart outlining an example operation for performance verification and feedback generation in accordance with one illustrative embodiment. As shown in FIG. 5, the operation starts by receiving user identification information (step 510). The user identification information is used to retrieve a user profile having preferences for verification modes when presenting interactive DIY multimedia content, as well as other preferences and user permissions (step 520). A user selection of an interactive DIY multimedia content is received (step 530) and an interactive execution workflow is generated based on the verification information metadata of the selected interactive DIY multimedia content and the user's profile information (step 540). The interactive DIY multimedia content is then presented to the user in accordance with the interactive execution workflow (step 550). The user's performance of the task/sub-tasks of the segments of the interactive DIY multimedia content is monitored by monitoring devices and evaluated in accordance with the verification information metadata of the segments of the interactive DIY multimedia content (step 560). In some illustrative embodiments, user health and biometrics may also be monitored (step 570). User feedback content is generated based on the monitoring in steps 560 and 570 (step 580). The user feedback content is presented to the user in accordance with the particular verification modes of the interactive execution workflow (step 590). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving multimedia content demonstrating performance of a task;
segmenting the multimedia content into a plurality of segments, each segment corresponding to a sub-task of the task;
determining, for each segment, one or more monitoring device identifications for monitoring devices to monitor performance of an associated sub-task of the segment;
determining, for each segment, one or more verification criteria for evaluating performance of the associated sub-task;
modifying, for each segment, metadata of the segment to include the one or more monitoring device identifications and one or more verification criteria, and thereby generate an interactive multimedia content; and
storing the interactive multimedia content in a repository for user access and monitoring of user performance of the task while the user accesses the interactive multimedia content.

2. The method of claim 1, wherein segmenting the multimedia content into a plurality of segments comprises executing an artificial intelligence computing tool that performs at least one of video splitting for identifying frames, speech-to-text conversion of audio of the multimedia content to generate a textual representation of the audio, natural language processing of the textual representation of the audio, and application of a language model or large language model to one of the audio, or a textual representation of the audio, of the multimedia content.

3. The method of claim 1, further comprising:
outputting the interactive multimedia content to a client computing device; and
monitoring, by monitoring devices corresponding to the one or more monitoring device identifications, for each segment in the plurality of segments, performance of a corresponding sub-task of the segment while outputting a portion of the interactive multimedia content for that segment.

4. The method of claim 3, wherein the monitoring is performed in accordance with one of a plurality of operation modes, wherein the plurality of operation modes comprises a learning mode in which a predetermined amount of drifting from the one or more verification criteria is permitted, an autonomous mode in which commands are automatically sent to equipment to perform the task automatically by the equipment, or an end user mode in which deviations from the one or more verification criteria are identified and trigger notifications of the deviations being output.

5. The method of claim 4, wherein in the learning mode, user feedback is output to the user after concluding output of the interactive multimedia content to the user, via a user computing device, wherein the user feedback identifies deviations of the user's performance of the task from the one or more verification criteria.

6. The method of claim 4, wherein in end user mode, user feedback is output to the user after concluding output of each segment of the interactive multimedia content to the user, via a user computing device, wherein the user feedback identifies deviations of the user's performance of the corresponding sub-task of the segment from the one or more verification criteria for the segment.

7. The method of claim 3, wherein monitoring performance of a corresponding sub-task of the segment comprises:
capturing, by one or more cameras, digital images of the user performing the sub-task; and
comparing the digital images to frames of the segment of the interactive multimedia content to determine deviations between the digital images and the frames.

8. The method of claim 1, wherein monitoring performance of a corresponding sub-task of the segment comprises:
capturing, by one or more sensors coupled to an element involved in the sub-task, sensor data characterizing a user performance of the sub-task with regard to the element; and
comparing the sensor data to the one or more verification criteria of the segment to determine deviations between the sensor data and the one or more verification criteria.

9. The method of claim 1, wherein the one or more monitoring device identifications comprises identifications of at least one of particular types of sensors for capturing monitoring data, particular cameras and computer vision tools to utilize, or software development kit (SDK) application programming interfaces (APIs) to use to monitor performance of corresponding sub-tasks of corresponding segments.

10. The method of claim 1, wherein the multimedia content comprises a video and corresponding audio of a do-it-yourself multimedia content informing viewers of how to perform the task.

11. A computer program product comprising:
one or more computer-readable storage media; and
program instructions stored on the one or more computer-readable storage media to perform operations comprising:
receiving multimedia content demonstrating performance of a task;
segmenting the multimedia content into a plurality of segments, each segment corresponding to a sub-task of the task;
determining, for each segment, one or more monitoring device identifications for monitoring devices to monitor performance of an associated sub-task of the segment;
determining, for each segment, one or more verification criteria for evaluating performance of the associated sub-task;
modifying, for each segment, metadata of the segment to include the one or more monitoring device identifications and one or more verification criteria, and thereby generate an interactive multimedia content; and
storing the interactive multimedia content in a repository for user access and monitoring of user performance of the task while the user accesses the interactive multimedia content.

12. The computer program product of claim 11, wherein segmenting the multimedia content into a plurality of segments comprises executing an artificial intelligence computing tool that performs at least one of video splitting for identifying frames, speech-to-text conversion of audio of the multimedia content to generate a textual representation of the audio, natural language processing of the textual representation of the audio, and application of a language model or large language model to one of the audio, or a textual representation of the audio, of the multimedia content.

13. The computer program product of claim 11, wherein the operations further comprise:
outputting the interactive multimedia content to a client computing device; and
monitoring, by monitoring devices corresponding to the one or more monitoring device identifications, for each segment in the plurality of segments, performance of a corresponding sub-task of the segment while outputting a portion of the interactive multimedia content for that segment.

14. The computer program product of claim 13, wherein the monitoring is performed in accordance with one of a plurality of operation modes, wherein the plurality of operation modes comprises a learning mode in which a predetermined amount of drifting from the one or more verification criteria is permitted, an autonomous mode in which commands are automatically sent to equipment to perform the task automatically by the equipment, or an end user mode in which deviations from the one or more verification criteria are identified and trigger notifications of the deviations being output.

15. The computer program product of claim 14, wherein in the learning mode, user feedback is output to the user after concluding output of the interactive multimedia content to the user, via a user computing device, wherein the user feedback identifies deviations of the user's performance of the task from the one or more verification criteria.

16. The computer program product of claim 14, wherein in end user mode, user feedback is output to the user after concluding output of each segment of the interactive multimedia content to the user, via a user computing device, wherein the user feedback identifies deviations of the user's performance of the corresponding sub-task of the segment from the one or more verification criteria for the segment.

17. The computer program product of claim 13, wherein monitoring performance of a corresponding sub-task of the segment comprises:
capturing, by one or more cameras, digital images of the user performing the sub-task; and
comparing the digital images to frames of the segment of the interactive multimedia content to determine deviations between the digital images and the frames.

18. The computer program product of claim 11, wherein monitoring performance of a corresponding sub-task of the segment comprises:
capturing, by one or more sensors coupled to an element involved in the sub-task, sensor data characterizing a user performance of the sub-task with regard to the element; and
comparing the sensor data to the one or more verification criteria of the segment to determine deviations between the sensor data and the one or more verification criteria.

19. The computer program product of claim 11, wherein the one or more monitoring device identifications comprises identifications of at least one of particular types of sensors for capturing monitoring data, particular cameras and computer vision tools to utilize, or software development kit (SDK) application programming interfaces (APIs) to use to monitor performance of corresponding sub-tasks of corresponding segments.

20. A computer system comprising:
a processor set;
one or more computer-readable storage media; and
program instructions stored on the one or more computer-readable storage media to cause the processor set to perform operations comprising:
receiving multimedia content demonstrating performance of a task;
segmenting the multimedia content into a plurality of segments, each segment corresponding to a sub-task of the task;
determining, for each segment, one or more monitoring device identifications for monitoring devices to monitor performance of an associated sub-task of the segment;
determining, for each segment, one or more verification criteria for evaluating performance of the associated sub-task;
modifying, for each segment, metadata of the segment to include the one or more monitoring device identifications and one or more verification criteria, and thereby generate an interactive multimedia content; and
storing the interactive multimedia content in a repository for user access and monitoring of user performance of the task while the user accesses the interactive multimedia content.
